(19) United States
(12) Patent Application Publication
(10) Pub. No.: US 2019/0107301 A1
(43) Pub. Date: Apr. 11, 2019

(54) FIBROUS DISPERSION AND FILTRATION AIR OUTLET SYSTEM

(71) Applicant: Massood Kamalpour, Davenport, FL (US)

(72) Inventor: Massood Kamalpour, Davenport, FL (US)

(21) Appl. No.: 15/727,612

(22) Filed: Oct. 8, 2017

(51) Int. Cl. F24F 3/16; B01D 46/02; B01D 46/00

(52) U.S. Cl. CPC F24F 3/1603; B01D 46/02; B01D 46/0006; B01D 2279/35; F24F 2003/1614; B01D 2265/023; B01D 46/0028

(57) ABSTRACT

The present invention relates to a fibrous dispersion and filtration air outlet system. A fibrous dispersion and filtration air outlet system comprises of an air outlet basket with a tumbling chamber, coupled with a vented base. Airflow from an HVAC air supply duct is channeled through a fibrous dispersion and filtration air outlet system, the airflow is tumbled, filtered of particulates and dispersed uniformly through the plurality of microscopic apertures of the filtration medium upon exiting the system.

### FIELD OF THE INVENTION

This invention relates generally to a system for providing a conventional heating, ventilation, and air conditioning (“HVAC”) air supply outlet with a fibrous air dispersion and filtration outlet system, designed to evenly disperse conditioned and filtered air within residential, commercial, or other building spaces.

### BACKGROUND OF THE INVENTION

Conventional HVAC air outlet covers such as grilles, registers and diffusers are commonly installed in ceilings, walls or floors and are used to control airflow from the HVAC air supply into a specific space. Generally, HVAC air outlet covers are constructed out of steel, aluminum, plastic or wood. Air outlet covers are designed in square, rectangular or round shapes with vent slats to regulate the direction and amount of airflow that passes through them. Typically, vent slat openings range in size from five millimeters to two centimeters or wider. Some grilles and registers offer vent slats in a single direction for airflow, while others offer two to more directions. Diffusers' vent slats are designed with a series of concentric rings or squares to diffuse air outward in a series of concentric circles.

The problem with existing air outlet covers is that their vent slats are so large that they fail to evenly disperse airflow when the HVAC system is in operation, the air currents created by the large vent slats can cause discomfort to people situated near the air outlets. Additionally, poorly dispersed airflow can also cause light weight objects such as paper to shift when the HVAC system is in operation. Furthermore, existing air outlet covers allow for dusts and other particulates to pass from the HVAC system into the air conditioned space unfiltered.

### SUMMARY OF THE INVENTION

The present invention provides a fibrous dispersion and filtration air outlet system that is compatible with conventional HVAC systems. Airflow from an HVAC air supply duct is channeled through a fibrous air dispersion and filtration outlet system, the air is filtered of particulates and the airflow is uniformly dispersed through the plurality of microscopic apertures of the filtration medium in a manner that prevents the creation of air currents; thus avoiding the aforementioned issues with existing air outlet covers.

### BRIEF DESCRIPTION OF THE DRAWINGS

FIG. 1 is a perspective view of a fibrous dispersion and filtration air outlet system.

FIG. 2 is a side view illustrating a sliding rail mechanism of a fibrous dispersion and filtration air outlet system.

FIG. 3 illustrates an air outlet basket (1) sliding into position on a sliding rail track (14) to cover a ceiling mounted vented base (9).

FIG. 4 illustrates a fully installed fibrous dispersion and filtration air outlet system.

FIG. 5 is an exploded perspective view illustrating airflow from an HVAC air supply (1) passing through a vented base (2, 3) and air outlet basket (6).

FIG. 6 is a perspective side view illustrating HVAC air supply (1) entering and filtered and dispersed air (4) exiting a fibrous dispersion and filtration air outlet system (2, 3).

FIG. 7 is an environmental view illustrating a fully installed a fibrous dispersion and filtration air outlet system (1, 2).

FIG. 8 is a perspective view of an air outlet basket (1) designed to be retrofitted to an existing HVAC air outlet.

FIG. 9 is an environmental view illustrating a transparent air outlet basket (1) retrofitted over an existing ceiling mounted HVAC air outlet (5).

FIGS. 10, and 11 are perspective views of varying attachment mechanism for retrofitting an air outlet basket to conventional HVAC air outlets.

### DETAILED DESCRIPTION

A system for providing HVAC air supply outlets with a fibrous dispersion and filtration air outlet system designed to evenly disperse conditioned and filtered air evenly within residential, commercial, or other building spaces. The present invention provides a fibrous air dispersion and filtration outlet system that is compatible with conventional HVAC systems. Airflow from an HVAC air supply duct is channeled through a fibrous dispersion and filtration air outlet system, the air is filtered of particulates and the airflow is dispersed uniformly through the plurality of microscopic apertures of the filtration medium upon exiting the system.

A fibrous dispersion and filtration air outlet system can be produced in any size and shape. Convectional HVAC air outlet covers are square, rectangular or round and the fibrous dispersion and filtration system can be sized and shaped to fit existing HVAC air supply ducts and air outlets.

The air outlet basket body in the accompanying drawings is shown as a dome; however, it could be any three dimensional shape that creates a chamber for air to tumble before being channeled through the plurality of microscopic apertures of a filtration medium.

The three dimensional structure of an air outlet basket body's filtration medium can be manufactured in a variety of ways including but not limited to using a pressed form, woven, or tented over a plastic, wood, or wire frame.

The filtration medium of an air outlet basket body can be manufactured from a variety of fibrous material including but not limited to: paper, wood, metal, gel compound, cotton, natural or manmade fibers, cellulose acetate, rayon, felt, fleece, fiberglass, cattail, stalks, plastic, and recycled compounds.

A fibrous dispersion and filtration air outlet system's air outlet baskets are designed to be disposable; used and replaced when an air outlet basket body's filtration medium is inundated with particulate build up. However, if a filtration medium is made from a material such as metal, it can be cleaned and such units can be reusable.

A fibrous dispersion and filtration air outlet system could be impregnated with an antimicrobial agent to eliminate or reduce harmful microorganisms that may pass through a HVAC system. This could help reduce the spread of microorganisms between members of a family in a home, staff in an office environment, or patients in a hospital setting. A fibrous dispersion and filtration system could also be infused with refreshing scents to gently freshen the air when a HVAC system is in operation.

A fibrous dispersion and filtration air outlet system can attach to a conventional HVAC system in a multiplicity of ways. The preferred embodiment of a fibrous dispersion and filtration air outlet system includes a proprietary vented base that is compatible with conventional HVAC air supply ducts. The proprietary vented base has vent slats that are arranged diverging from a center and emanating outward radially. The proprietary vented base is designed with a sliding track rail mechanism for easy insertion and replacement of the air outlet basket. The vented base could be manufactured out of steel, aluminum, plastic or wood.

Alternately, a fibrous dispersion and filtration air outlet system can attach to an existing HVAC air outlet cover such as grilles, registers and diffusers by retrofitting an air outlet basket to fit an existing HVAC air outlet cover. This can be achieved in many way, for example, by designing a fibrous air dispersion and filtration system with screw mounting brackets, double sided mounting tape, magnetized strips, or hook-and-loop fasteners. The existing HVAC air outlet cover performs the function of a vented base.

In the following description, references are made to the accompanying drawings that illustrate various embodiments of the invention, it is to be noted that other embodiments are contemplated and may be made without departing from the scope or concept of the present invention. Thus, the following description is not to be taken as a limitation to the scope or concept of the invention but as a means to provide example for the invention. Reference numbers in one drawing may not relate to reference numbers in any other drawing.

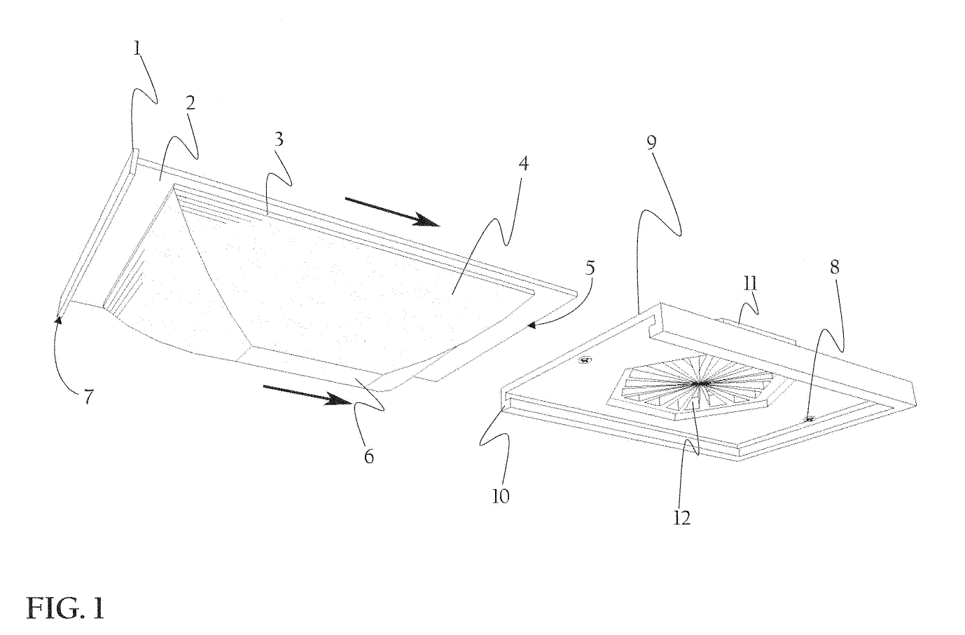

Turning to the drawings, FIG. 1 shows a preferred embodiment of a fibrous dispersion and filtration air outlet system comprising of an air outlet basket (1) and a proprietary vented base (9). An air outlet basket (1) comprises of an air outlet basket body (4) made from a multilayer filtration medium (6), pressed into a molded dome form. An air outlet basket body (4) creates a tumbling chamber that allows air to tumble before being forced through the plurality of microscopic apertures of a multilayer filtration medium (6).

An air outlet basket body (4) includes a basket rim edge (3) that is affixed to a basket rim (2) which frames an air outlet basket body (4) creating a mechanism for installing an air outlet basket (1) to a vented base (9). A basket rim (2) has an anterior end (5) for insertion into a vented base (9) in the direction shown by the arrow, and a posterior end (7) with a handle that creates a seal when fully inserted.

A vented base (9) attaches to a conventional HVAC air supply duct with screws (8). A vented base (9) comprises of a duct opening (11) for airflow from an HVAC air supply. The air passes from the duct opening (11) through the vent slats (12) which breaks up the airflow before it enters an air outlet basket body's (4) tumbling chamber. A vented base (9) provides a sliding rail (10) for easy installation and replacement of an air outlet basket (1).

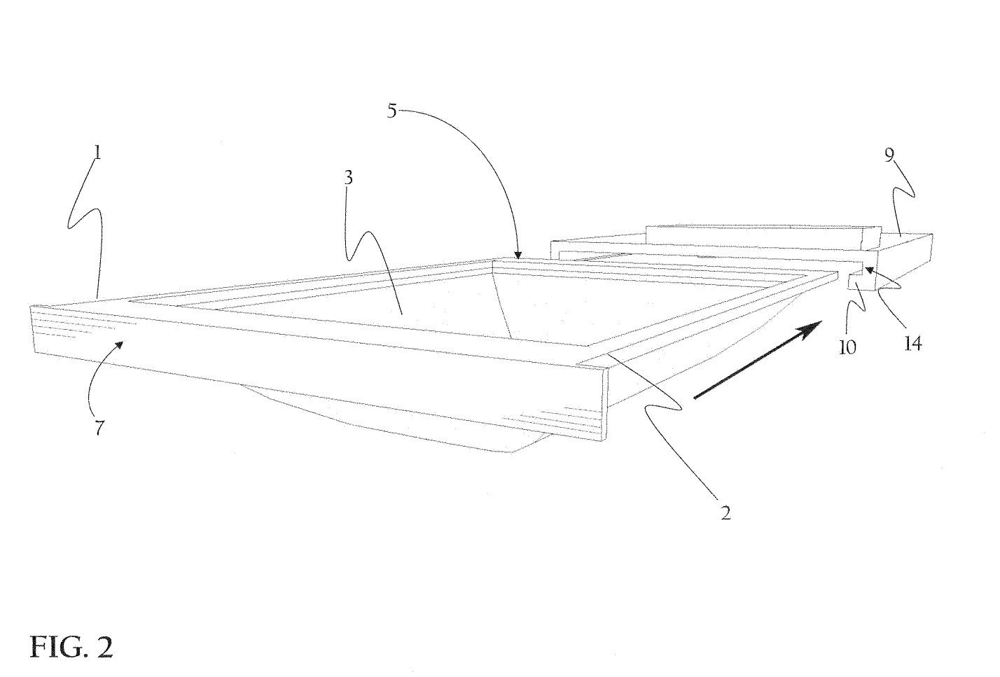

FIG. 2 is a side view illustrating a fibrous dispersion and filtration air outlet system's sliding rail mechanism and an air outlet basket's tumbling chamber. While holding an air outlet basket (1) by its basket rim (2) handle at its posterior end (7), a basket rim's (2) anterior end (5) slides into a vented base (9) in the direction show by the arrow, onto a sliding rail (10) at the open end of a sliding track (14). Once an air outlet basket (1) is fully inserted into a vented base (9), an air outlet basket's tumbling chamber (3) will receive airflow channeled through a vented base (9) from an HVAC air supply duct.

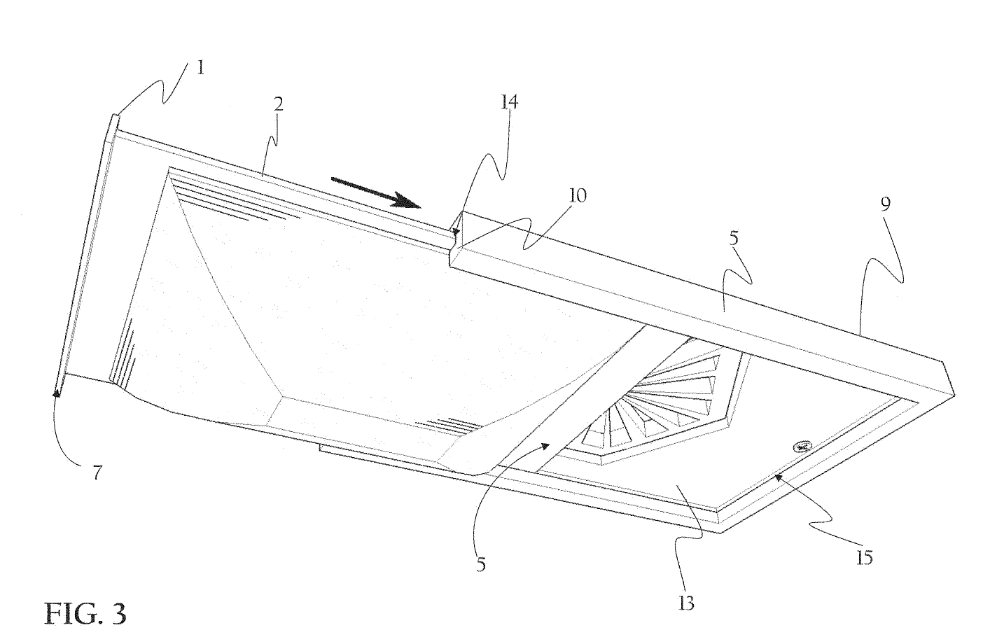

FIG. 3 illustrates an air outlet basket (1) sliding into position on a sliding rail track (14) to cover a vented base (9). Once an air outlet basket (1) is fully inserted into a vented base (9), the basket rim (2) is flush against the base plate (13) of a vented base (9); and the anterior end (5) of a basket rim (2) is fully inserted into the closed end of a sliding track (15).

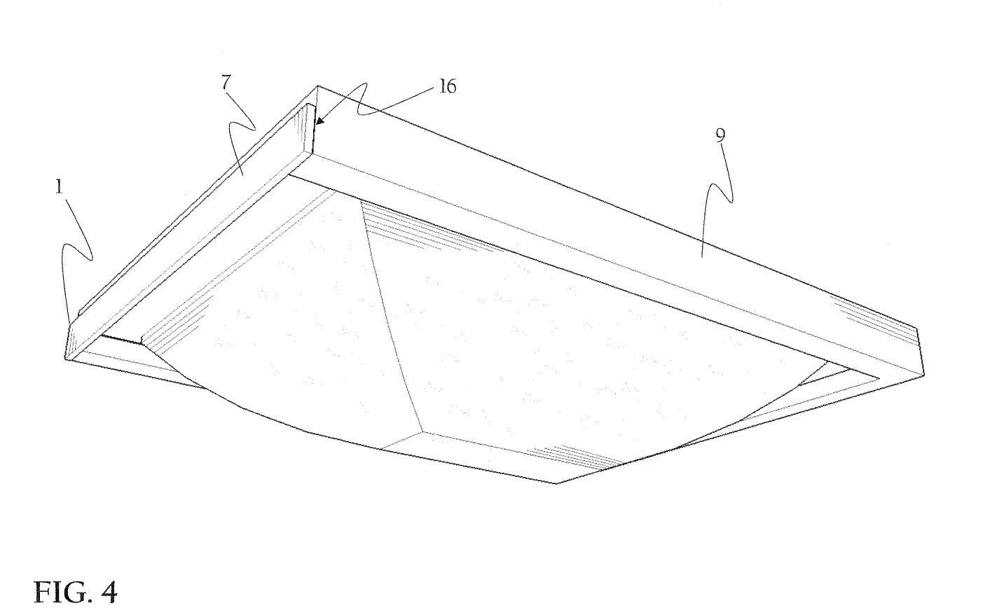

FIG. 4 illustrates a fully installed fibrous dispersion and filtration air outlet system with an air outlet basket (1) completely inserted into a vented base (9); upon complete insertion, a basket rim's posterior end (7) is flush against a vented base (9) and creates a seal (16).

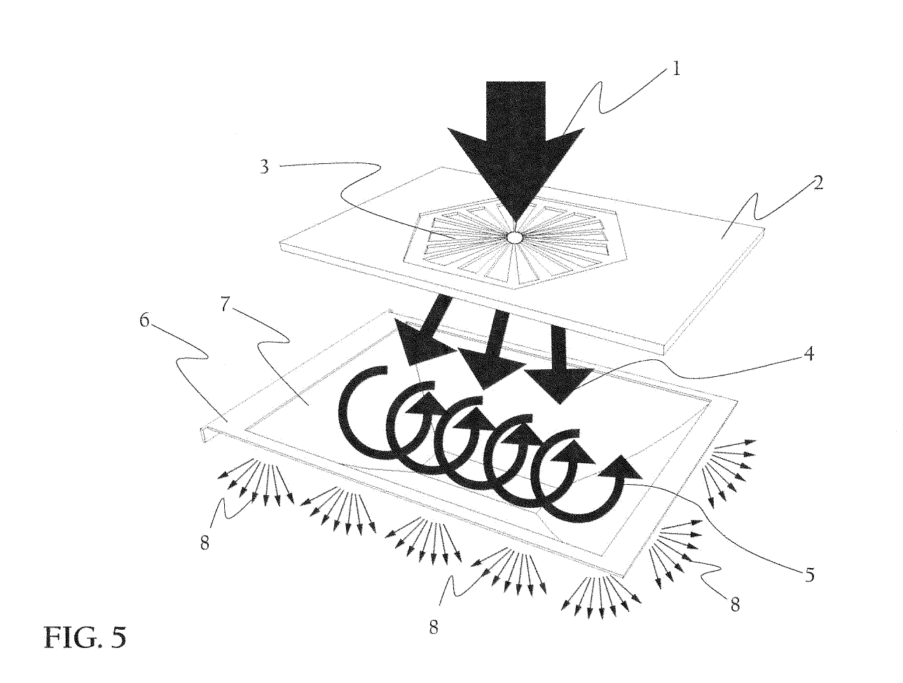

FIG. 5 is an exploded perspective view of a fibrous dispersion and filtration air outlet system, illustrating airflow entering and exiting the system. Note that the sliding rail track of the vented base (2) has been removed for illustrative purposes. First, airflow from an HVAC air supply duct (1) enters the system, the airflow is broken down as it passes through vent slats (3) of a vented base (2). Second, the vented airflow (4) tumbles (5) in the tumbling chamber of an air outlet basket (6). Finally, airflow is channeled through the plurality of microscopic apertures of the multilayer filtration medium (7) dispersing filtered air (8) evenly throughout the air conditioned space.

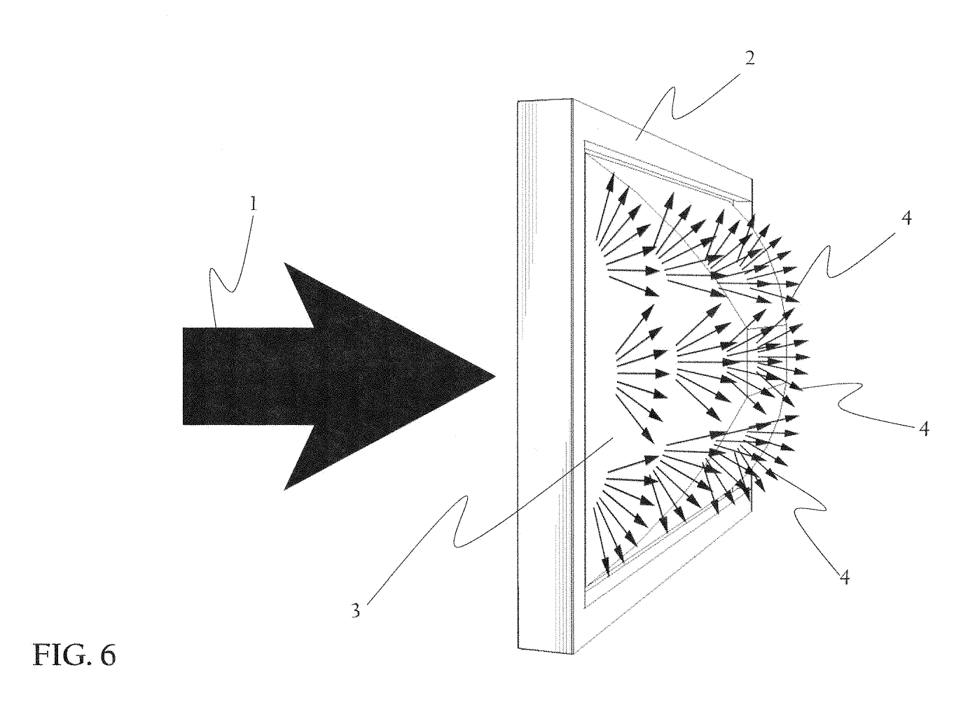

FIG. 6 is a perspective side view illustrating a large current of unfiltered airflow from an HVAC air supply (1) entering a fibrous dispersion and filtration air outlet system (2) followed by the airflow exiting through a plurality of microscopic apertures of the multilayer filtration medium (3) dispersing filtered air (4) evenly throughout an air conditioned space.

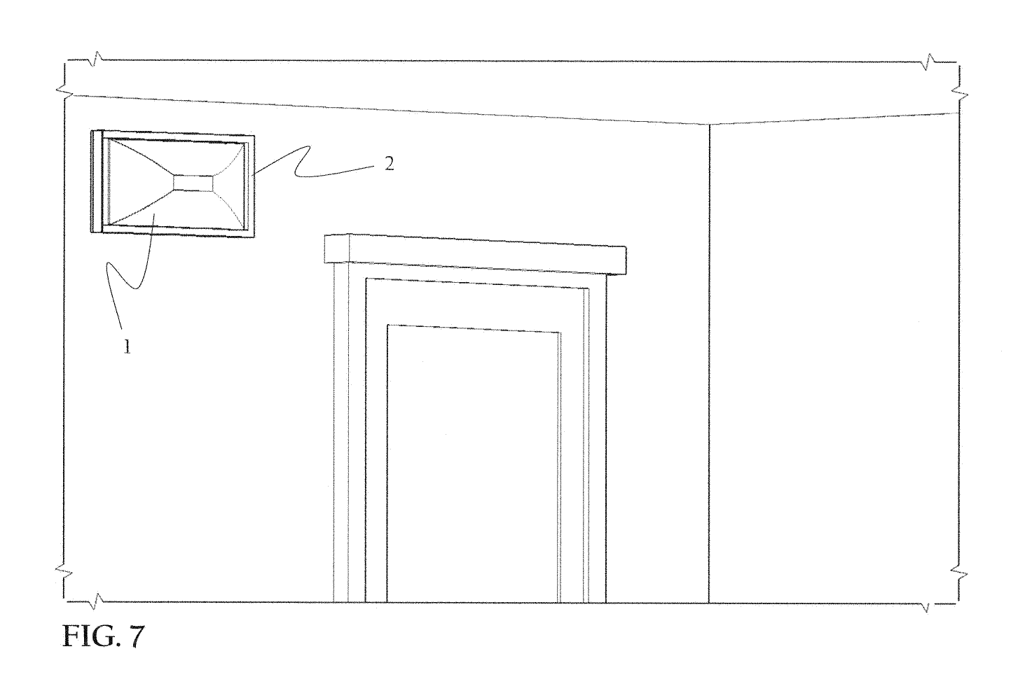

FIG. 7 is an environmental view that illustrates an example of a fully installed fibrous dispersion and filtration air outlet system with a completely inserted air outlet basket (1) into a wall mounted vented base (2).

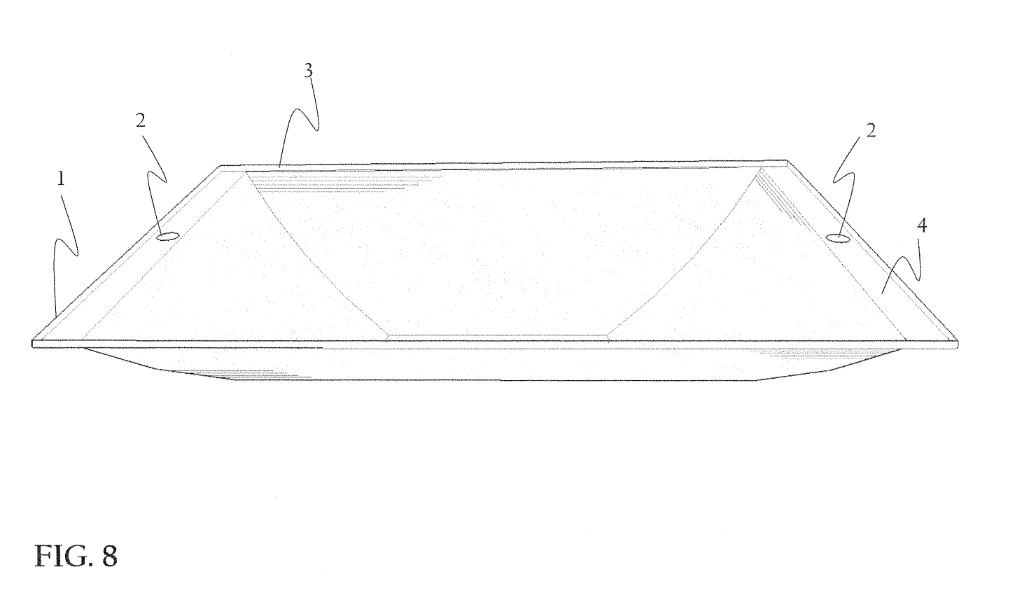

FIG. 8 is a perspective view of a fibrous dispersion and filtration air outlet system for retrofitting onto a conventional HVAC air outlet covers such as a grille, register, or diffuser. An existing HVAC air outlet cover performs the function of a vented base. An air outlet basket (1) can be sized to match existing HVAC air outlets. This embodiment of an air outlet basket (1) has a lip (3) and a basket rim (4) to fully cover an existing HVAC air outlet and screw holes (2) for attachment to the existing HVAC air outlet cover.

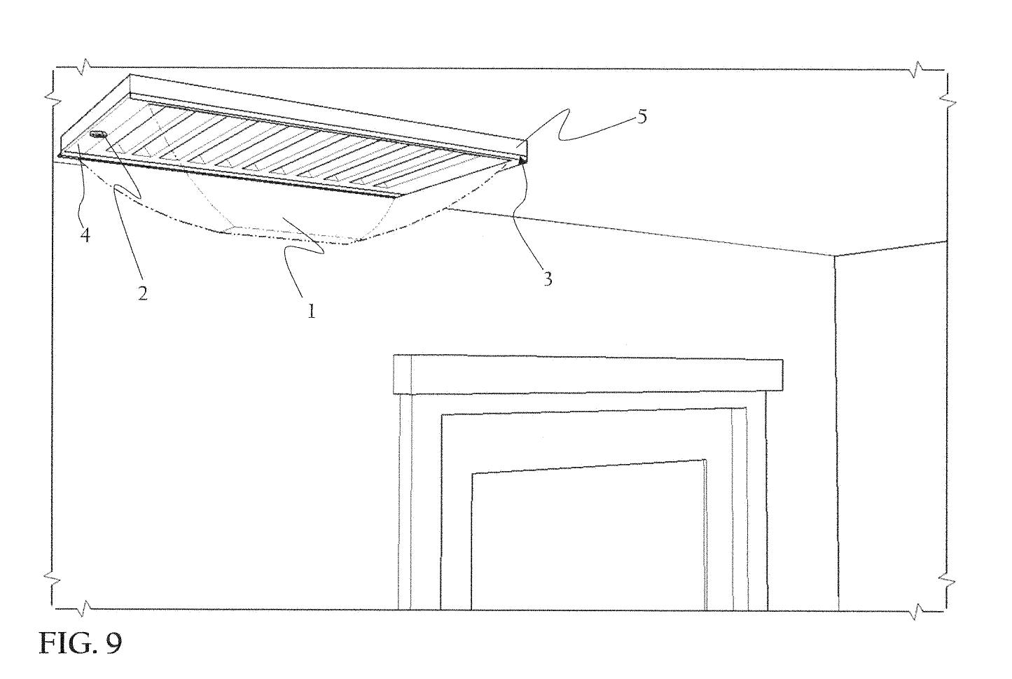

FIG. 9 is a transparent environmental view of a retrofitted fibrous dispersion and filtration air outlet system installed over an existing ceiling mounted HVAC air outlet cover. The figure illustrates an air outlet basket (1) covering a conventional ceiling mounted HVAC air outlet (5) which acts as a vented base. A lip (3) and a basket rim (4) fully cover an existing ceiling mounted HVAC air outlet (5) and screws (2) attach an air outlet basket (1) onto an existing ceiling mounted HVAC air outlet (5).

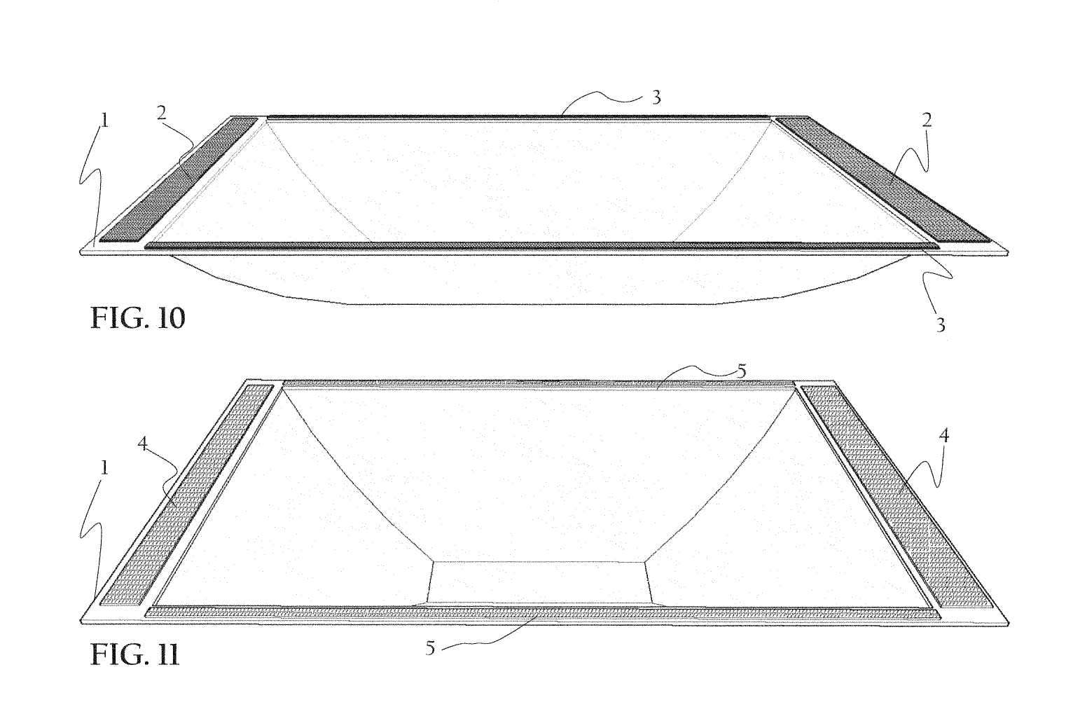

FIG. 10 is a perspective view of an air outlet basket (1) with magnet strips (2, 3) for retrofitting onto an existing metal HVAC air outlet.

FIG. 11 is a perspective view of an air outlet basket (1) with hook-and-loop fastener strips (4, 5) for retrofitting onto an existing HVAC air outlet. What is not shown is the corresponding hook-and-loop fastener strips that adhere to an existing HVAC air outlet cover.

1. A fibrous air dispersion and filtration air outlet system for evenly dispersing and filtering particulate in conjunction with a conventional forced air heating, ventilation and cooling system, comprising:
a vented base plate structure having a plurality of ventilation slats with an inner surface positionable over a heating, ventilation and cooling system (HVAC) air supply duct and an outer surface;
a fibrous filter press formed into a three dimensional shape having an opening creating an inner cavity for tumbling and filtering air and an outer surface facing an area being conditioned, said inner cavity of said fibrous filter facing said outer surface of said vented base plate, wherein said fibrous filter comprises one or more layers for filtering air and a plurality of microscopic apertures for uniformly dispersing said filtered air in a plurality of directions; and
a fastening mechanism that couples said fibrous filter to said vented base plate, said inner cavity of said fibrous filter substantially covering said outer surface of said vented base plate, said fibrous filter being mobile to be removed and replaced when desired.

2. The fibrous dispersion and filtration air outlet system of claim 1, wherein said fibrous filter is woven into a three dimensional shape having an opening creating an inner cavity for tumbling and filtering air, and an outer surface facing the area being conditioned, said inner cavity of said fibrous filter faces the said outer surface of said vented base plate.

3. (canceled)

4. The fibrous dispersion and filtration air outlet system of claim 1, wherein said fibrous filter is press formed into a dome having an opening creating an inner cavity for tumbling and filtering air, and an outer surface facing the area being conditioned, said inner cavity of said fibrous filter faces the said outer surface of said vented base plate.

5. The fibrous dispersion and filtration air outlet system of claim 1, wherein said plurality of ventilation slats are arranged diverging from a center and emanating outward radially.

6. The fibrous dispersion and filtration air outlet system of claim 1, wherein said vented base plate is a conventional HVAC outlet cover.

7. The fibrous dispersion and filtration air outlet system of claim 1, wherein said fastening mechanism is a sliding rail.

8. The fibrous dispersion and filtration air outlet system of claim 1, wherein said fastening mechanism is a magnet.

9. The fibrous dispersion and filtration air outlet system of claim 1, wherein said fastening mechanism is a screw opening.

10. The fibrous dispersion and filtration air outlet system of claim 1, wherein said fastening mechanism is a magnetic tape.

11. The fibrous dispersion and filtration air outlet system of claim 1, wherein said fastening mechanism is a hook and loop fastener.

12. The fibrous dispersion and filtration air outlet system of claim 1, wherein said fastening mechanism is a double sided tape.

13. A fibrous air dispersion and filtration air outlet system for evenly dispersing and filtering particulate in conjunction with a conventional forced air heating, ventilation and cooling system, comprising:
a vented base plate structure having a plurality of ventilation slats with an inner surface positionable over a heating, ventilation and cooling system (HVAC) air supply duct and an outer surface;
a fibrous filter press formed into a three dimensional shape having an opening creating an inner cavity for tumbling and filtering air and an outer surface facing an area being conditioned, said inner cavity of said fibrous filter facing said outer surface of said vented base plate, wherein said fibrous filter is disposable and is infused with one or more of an antimicrobial agent, an odor removing agent, or an odor supplementing agent; and
a fastening mechanism that couples said fibrous filter to said vented base plate, said inner cavity of said fibrous filter substantially covering said outer surface of said vented base plate, said fibrous filter being mobile to be removed and replaced when desired.

14. The fibrous dispersion and filtration air outlet system of claim 13, wherein said plurality of ventilation slats are arranged diverging from a center and emanating outward radially.

15. The fibrous dispersion and filtration air outlet system of claim 13, wherein said vented base plate is a conventional HVAC outlet cover.

16. The fibrous dispersion and filtration air outlet system of claim 13, wherein said fastening mechanism is a sliding rail.

17. The fibrous dispersion and filtration air outlet system of claim 13, wherein said fibrous filter comprises a plurality of layers for filtering air.

18. The fibrous dispersion and filtration air outlet system of claim 13, wherein said fibrous filter comprises a plurality of microscopic apertures for uniformly dispersing said filtered air.

19. The fibrous dispersion and filtration air outlet system of claim 13, wherein said fibrous filter is formed from one or more of paper, wood, metal, gel compound, cotton, natural fiber, manmade fiber, cellulose acetate, rayon, felt, fleece, fiberglass, cattail, stalk, plastic, or recycled compounds.

20. The fibrous dispersion and filtration air outlet system of claim 13, wherein said vented base plate is formed from one or more of steel, aluminum, plastic, or wood.

21. A fibrous air dispersion and filtration air outlet system for evenly dispersing and filtering particulate in conjunction with a conventional forced air heating, ventilation and cooling system, comprising:
a vented base plate structure having a plurality of ventilation slats with an inner surface positionable over a heating, ventilation and cooling system (HVAC) air supply duct and an outer surface;
a fibrous filter tented over a three dimensional shape having an opening creating an inner cavity for tumbling and filtering air and an outer surface facing an area being conditioned, said inner cavity of said fibrous filter facing said outer surface of said vented base plate, wherein said fibrous filter comprises one or more layers for filtering air and a plurality of microscopic apertures for uniformly dispersing said filtered air in a plurality of directions; and
a fastening mechanism that couples said fibrous filter to said vented base plate, said inner cavity of said fibrous filter substantially covering said outer surface of said vented base plate, said fibrous filter being mobile to be removed and replaced when desired.

22. The fibrous dispersion and filtration air outlet system of claim 21, wherein said plurality of ventilation slats are arranged diverging from a center and emanating outward radially.

23. The fibrous dispersion and filtration air outlet system of claim 21, wherein said vented base plate is a conventional HVAC outlet cover.

24. The fibrous dispersion and filtration air outlet system of claim 21, wherein said fastening mechanism is a sliding rail.

25. The fibrous dispersion and filtration air outlet system of claim 21, wherein said fibrous filter is formed from one or more of paper, wood, metal, gel compound, cotton, natural fiber, manmade fiber, cellulose acetate, rayon, felt, fleece, fiberglass, cattail, stalk, plastic, or recycled compounds.

26. The fibrous dispersion and filtration air outlet system of claim 21, wherein said vented base plate is formed from one or more of steel, aluminum, plastic, or wood.

27. The fibrous dispersion and filtration air outlet system of claim 1, wherein said fibrous filter is formed from one or more of paper, wood, metal, gel compound, cotton, natural fiber, manmade fiber, cellulose acetate, rayon, felt, fleece, fiberglass, cattail, stalk, plastic, or recycled compounds.

28. The fibrous dispersion and filtration air outlet system of claim 1, wherein said vented base plate is formed from one or more of steel, aluminum, plastic, or wood.
